(19) United States
(12) Patent Application Publication
(10) Pub. No.: US 2016/0321618 A1
(43) Pub. Date: Nov. 3, 2016

(54) SYSTEM AND METHOD FOR RECOMMENDING TARGET LOCATIONS

(71) Applicant: KONINKLIJKE PHILIPS N.V., Eindhoven (NL)

(72) Inventors: Michael Martin SCHEJA, SHANGHAI (CN); Renjun YU, SHANGHAI (CN); Vikrant Suhas VAZE, WHITE PLAINS, NY (US); Hanqing CAO, MAHWAH, NJ (US); Saeed Reza BAGHERI, CROTON, NY (US); Choo Chiap CHIAU, SHANGHAI (CN); Yugang JIA, BRIARCLIFF MANOR, NY (US); Mina DENG, SHANGHAI (CN); Bin YIN, SHANGHAI (CN)

(21) Appl. No.: 15/105,044

(22) PCT Filed: Dec. 23, 2014
(86) PCT No.: PCT/EP2014/079102

§ 371 Date: Jun. 16, 2016

(30) Foreign Application Priority Data
Dec. 30, 2013 (CN) PCT/CN2013/001658
Jan. 29, 2014 (EP) 14153065.9

(51) Int. Cl. G06Q 10/10; G01C 21/34; G01C 21/36; H04L 29/08

(52) U.S. Cl. CPC G06Q 10/1097; H04L 67/18; G01C 21/343; G01C 21/3691

(57) ABSTRACT

There is provided a method of generating a recommendation for one or more target locations for running a target errand. The method generates a recommendation for at least one candidate location as the target location,based on a waiting time and a travel time predicated according to target time schedules. Also, there are provided a device and system to provide the recommendation for target locations.

### FIELD OF THE INVENTION

The invention relates to a method, device and system for generating a recommendation for one or more target locations for running a target errand.

### BACKGROUND OF THE INVENTION

People spend significant amounts of time getting to establishments which can cater to the necessities of daily life. Apart from a loss of quality time, this can be physically exhausting, especially for elderly people. Recently, communication systems for providing various services including reservations for amusement facilities or restaurants have been proposed. They can be combined with a navigation system to provide a recommended transportation route. By using this system, one can travel through an optimum route, while getting various services. For example, the Google map or Baidu map may give an option to the user by recommending some candidate locations in a range of his current location to get a certain service. It can also give further information about how much time it will take the user to arrive at a specific location. However, the recommendations are mainly based on the distance from the user's current location to the target location and they are not optimal with respect to the intended service.

### SUMMARY OF THE INVENTION

The present application aims to provide an improved method and system for generating a recommendation for a target location that can facilitate the user to get a certain service more quickly.

According to a first aspect of the present invention, there is provided a method of generating a recommendation for one or more target locations for running a target errand. When a user intends to run the target errand, one or more target time schedules are determined. The user's location is identified as well as one or more candidate locations where the user can run the target errand. According to the target time schedules, a travel time from the user's location to each of the candidate locations is predicated, and a waiting time for running the target errand at each of the candidate locations is estimated according to the target time schedules. Then a recommendation for at least one of the candidate locations as the target location is generated based on the waiting time and the travel time.

The invention is based on the notion of the above-mentioned problem of known recommendation methods that the recommended route or location is not optimal with respect to a specific service. The inventor realized that to run an errand at a public establishment, a user must I) travel to a particular location where the establishment is situated, and II) queue at the establishment to get a certain service, e.g. at a counter, from a cashier etc. The current solutions just provide a simple estimation of the travel time solely based on the distance between the current location and the target location. However, the user may be interested in the total time required to run the errand rather than only one part of it. Sometimes the second step may require significantly more time than the first step, making such existing solutions unsuitable, from the user's point of view, for predicting the actual time so as to enable him to arrange his activities. The present solution as described above considers both aspects and overcomes the disadvantage described above by giving an estimation of the total time required to run the errand, including waiting time and travel time.

According to an embodiment of the present invention, the present solution predicts both the travel time and the waiting time by taking the target time schedules into account. This facilitates the users to arrange their future activities and makes it possible to consider other relevant factors, such as the traffic situation at the scheduled time.

According to an embodiment, to predicate the travel time the method further determines available routes and/or available means of transportation from the user's location to each of the candidate locations. Additionally or alternatively, the traffic data are further categorized by day of a week, weather, and/or holiday. Therefore, the travel time can be more accurately predicated by using traffic data pertaining to similar situations. According to an embodiment, the travel time of a certain route is determined

by selecting a route from a plurality of available routes, dividing the selected route into multiple segments, estimating a segment time for each of the multiple segments from historical traffic data and/or real-time traffic data according to the target time schedules, and adding up all estimated segment times for the selected route.

According to an embodiment, the waiting time at each candidate location is estimated by: determining the crowdedness at a candidate location, based on historical data and/or surveillance data of the candidate location according to the target time schedules, determining a processing speed at the candidate location, and estimating the waiting time according to the crowdedness and the processing speed.

Generally, the waiting time is determined from the historical crowdedness, because real-time congestion data is not always available e.g. when the user chooses a time schedule that is still a few days away. Similarly, the processing speed can either be a speed currently monitored at the candidate location, or a speed derived from a historical database, for example, when the waiting time is estimated several days before the scheduled time.

According to an embodiment, the crowdedness is determined from the registration data at a candidate location, the amount of cars at a candidate location, the number of people entering a candidate location, and/or the CO₂ concentration at a candidate location.

According to an embodiment, the waiting time is estimated according to the target time schedules and the travel time. By taking the travel time into account, the waiting time can be more accurately estimated.

According to a second aspect of the present invention, there is provided a device for generating a recommendation for one or more target locations for running a target errand. The device includes a schedule setting module for determining one or more target time schedules when a user intends to run the target errand, a location identifying module for identifying a user's location and one or more candidate locations where the user can run the target errand, a travel time predicating module for predicating a travel time from the user's location to each of the candidate locations according to the target time schedules, a waiting time estimating module for estimating a waiting time for running the target errand at each of the candidate locations according to the target time schedules, and a recommending module for generating a recommendation for at least one of the candidate locations as the target location, based on the waiting time and the travel time.

According to another aspect of the present invention, a system for generating a recommendation for one or more target locations for running a target errand is provided. The system comprises the device as mentioned above, and historical data storage means communicatively coupled to the device. The historical data storage means is configured to provide information selected from a group comprising: candidate locations for different types of errands, available routes and/or means of transportation to the candidate locations, historical traffic data, and/or historical crowdedness data at the candidate locations.

The above object of the present invention also can be achieved by means of a computer readable storage medium comprising instructions stored thereon that are responsive to execution by a processor, causing the processor to perform a method according to the first aspect of the present invention.

In the present application, the term “errand” refers to a task a user wants to perform. To run an errand, a user must travel to a particular location where the establishment is situated, and queue at the establishment to get a certain service. Public establishments may be a post office, a supermarket, a hospital, a restaurant, a shopping mall, or a building center and the like. Generally, there are several establishments in a local place and the user needs to determine which specific establishment to go to get a certain service. At each establishment, there may be many users waiting to get the service. The crowdedness of the establishment is used to represent the density of population at the establishment.

Further advantageous embodiments of the invention are described in the dependent claims. These and other aspects of the invention will be apparent from and elucidated with reference to non-limiting embodiments described hereafter, and shown in the drawings.

### BRIEF DESCRIPTION OF THE DRAWINGS

FIG. 1 illustrates a diagram of a target recommendation system according to an embodiment of the present invention;

FIG. 2 illustrates a diagram of a target recommendation device according to an embodiment of the present invention;

FIG. 3 is a flowchart illustrating procedures of the target recommending method according to an embodiment of the present invention;

FIGS. 4a,b are display examples to show how a user interfaces with the target recommending device;

FIG. 5 illustrates an example of estimating the travel time according to an embodiment of the present invention;

FIG. 6 illustrates how the travel time varies under different weather conditions; and

FIG. 7 illustrates how the waiting time is estimated in real time using a monitoring device according to an embodiment of the present invention.

### DETAILED DESCRIPTION OF PREFERRED EMBODIMENT

Similar or corresponding features are denoted by similar or corresponding reference numerals in the present patent application. Some preferred embodiments of the present invention will now be described in greater detail. However, it should be noted that the preferred embodiments of the present invention are provided merely for illustration and should not be construed as being limitative. Additionally, the present invention can be practiced in a wide range of embodiments other than those explicitly described, and the scope of the present invention is not expressly limited except as specified in the accompanying claims.

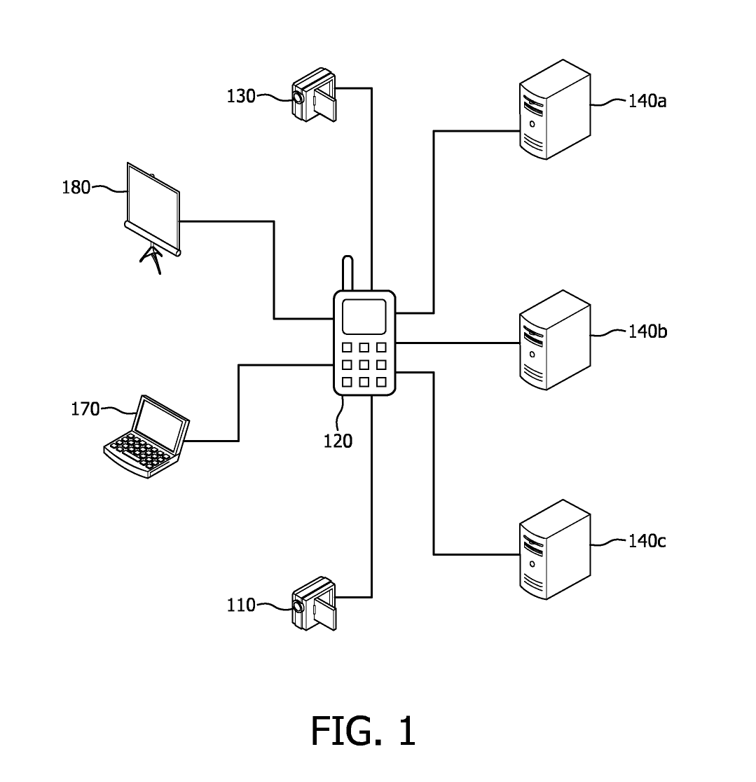

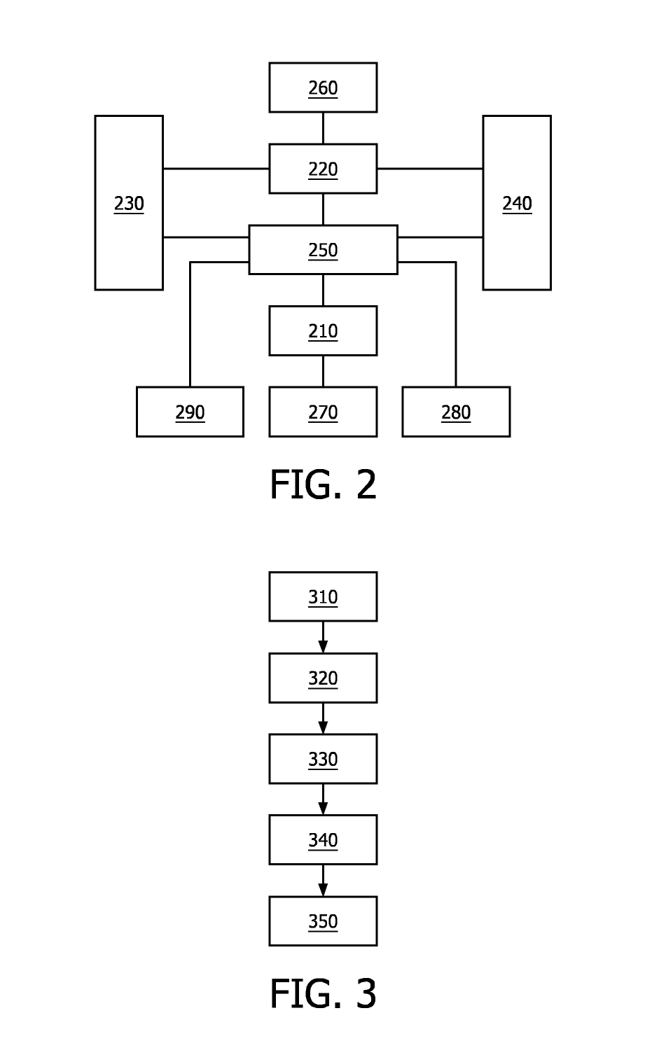

FIG. 1 schematically depicts a non-limiting embodiment of a target recommendation system 100. The system is configured to provide a recommendation for one or more target locations to a respective user (not shown) so as to get an intended service at the one or more target locations. For example, the system 100 comprises a target recommendation device 120, an input unit 170, a display 180, monitoring devices 110, surveillance devices 130, databases 140a,b,c. The target recommendation device 120 is configured to perform the recommendation operations, and its structure and operation will be described in detail in the following with reference to FIG. 2 and FIG. 3. The target recommendation device 120 may be a portable electronic device, for example, a mobile phone, a smart phone, a portable game console, a personal digital assistant (PDA), a notebook or a Tablet PC. The target recommendation device 120 is connected by wires or wirelessly to one or more databases 140 of the target recommendation system 100. The database 140a contains historical traffic information, and the database 140b contains historical crowdedness data of a particular establishment. Although the figure only shows one crowdedness database 140b, the person skilled in the art may understand that each establishment may have its own crowdedness database and the target recommendation device 120 may be connected to the crowdedness database of each establishment, as needed. Alternatively, the crowdedness data may be collected and managed by a data center and there is only one crowdedness database. The database 140c is a database of public establishments. A user can retrieve the available establishments according to a service he wants to receive. For example, if the user wants to visit a cardiologist, he can retrieve all the hospitals within a certain radius(?) having a cardiology department. Preferably, the database 140c can additionally provide the specific location of the available establishment.

The target recommendation device 120 is connected to a display 180 for showing a recommendation of target locations, and to an input unit 170 which is provided integrally with or independently of the display 180.

The target recommendation device 120 is also connected to one or more monitoring devices 110 and one or more surveillance devices 130. The monitoring device 110 is configured to provide real-time traffic data of a road and the surveillance device 130 is configured to provide real-time crowdedness data at a particular establishment.

When the user attempts to get a recommendation for a target location by using the target recommendation system 100, the user enters necessary information, such as the desired scheduled time, the type of intended errand, for example, to visit a doctor, to go to a bank, or some shopping market, etc. Upon receiving the information, the target recommendation device 120 accesses the database 140c of public establishments and uses the user's location and user's input of the establishment to be visited to identify relevant establishments in the neighborhood. After these establishments have been identified, traffic conditions (real time and/or historical) are taken into account as basis for travel time prediction. The target recommendation device 120 further uses real-time and/or registration data of the identified establishments to estimate the crowdedness at these locations. Based on the crowdedness estimation, the waiting time at each of the identified locations is predicated.

The journey-time prediction data and waiting-time prediction data are now used by the target recommendation device 120 to provide recommendations and comparisons of the most time-efficient options. A procedure for generating the recommendation for target locations will be described with reference to the diagram in FIG. 2 and the flowchart illustrated in FIG. 3.

FIG. 2 illustrates a target recommendation device 120 according to an embodiment of the present invention. The target recommendation device can be used in the target recommendation system 100 to cooperate with the monitoring devices 110, surveillance device 130, databases 140a,b,c. The target recommendation device 120 may comprise a schedule setting module 210, a location identifying module 220, a travel time predicating module 230, a waiting time estimating module 240 and a recommending module 250. The schedule setting module 210 determines one or more target time schedules when a user intends to run the target errand according to the information input by the user through an input module 270.

The location identifying module 220 identifies the user's location and one or more candidate locations where the user can run the target errand. Preferably, the target recommendation device 120 comprises a sensor, such as a GPS 260, to sense the current location of the user. The current location may be used directly by the location identifying module 220 if the user wants to run the errand at this moment, or is scheduled as a starting point for a later point in time. Additionally or alternatively, the user may change the location by using the input module 270 of the target recommendation device 120, if he schedules to run his errand from another position later.

After receiving the schedule times and the locations, the travel time predicating module 230 predicates a travel time from the user's location to each of the candidate locations according to the target time schedules. Similarly, the waiting time estimating module 240 estimates a waiting time for running the target errand at each of the candidate locations according to the target time schedules. Based on the waiting time and the travel time, the recommending module 250 generates a recommendation for at least one of the candidate locations as the target location. Preferably, the target recommendation device 120 comprises a display 280 for displaying the recommended candidate locations. For example, the recommended candidate locations can be displayed in ascending order according to the sum of the waiting time and the travel time. The display 280 and the input module 270 can be replaced with a touch-sensitive screen having input functions. The target recommendation device 120 may further comprise a communication interface 290 for communicating with the monitoring devices 110, the surveillance devices 130, databases 140a,b,c to get the traffic data, the crowdedness data etc.

FIG. 3 is a flowchart illustrating procedures of the target recommending method according to an embodiment of the present invention. The method can be performed by the target recommendation device 120 or by an appropriately programmed processor.

It starts with determining 310 one or more target time schedules indicating when the user intends to run the target errand. This can be achieved by manual input through the input module 270. In one embodiment, the target recommendation device 120 may display a user interface on its display 280, or alternatively a touch-sensitive screen, which allows a user to start a request by providing relevant information about the activity he wants to perform, e.g. visiting a cardiologist. The user may input relevant information through the input module, for example, the type of establishment. In this case, he selects a hospital with a cardiology department. Furthermore, the user can set time schedules at which the user would like to visit the cardiologist, for example by setting date and time options.

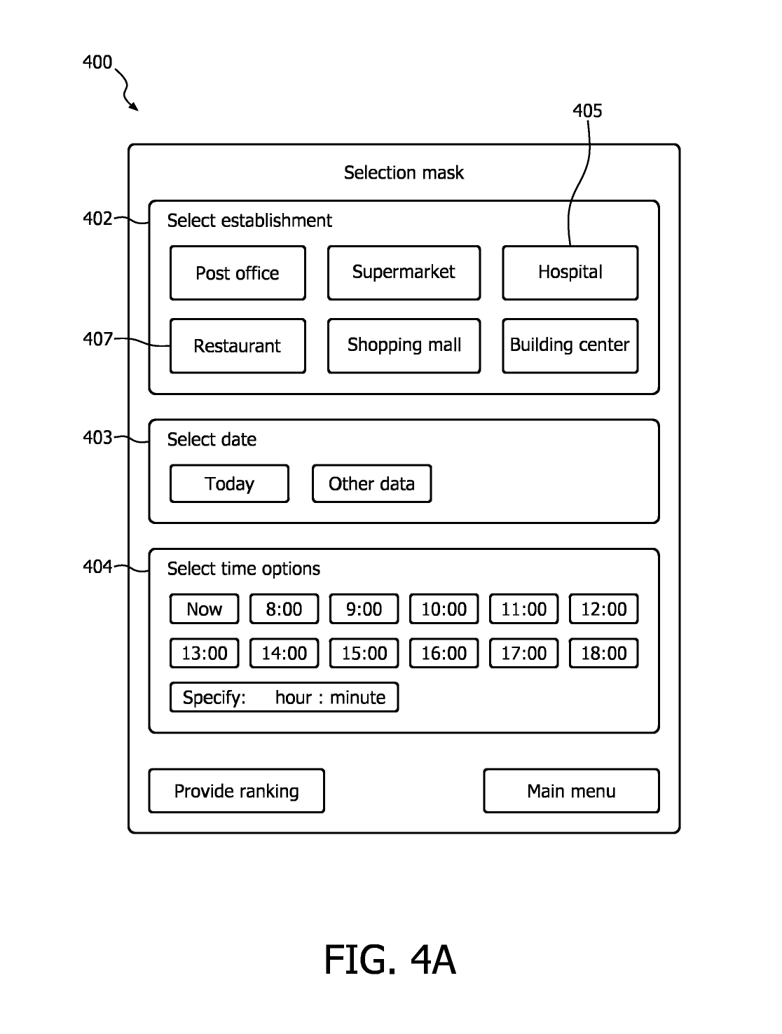

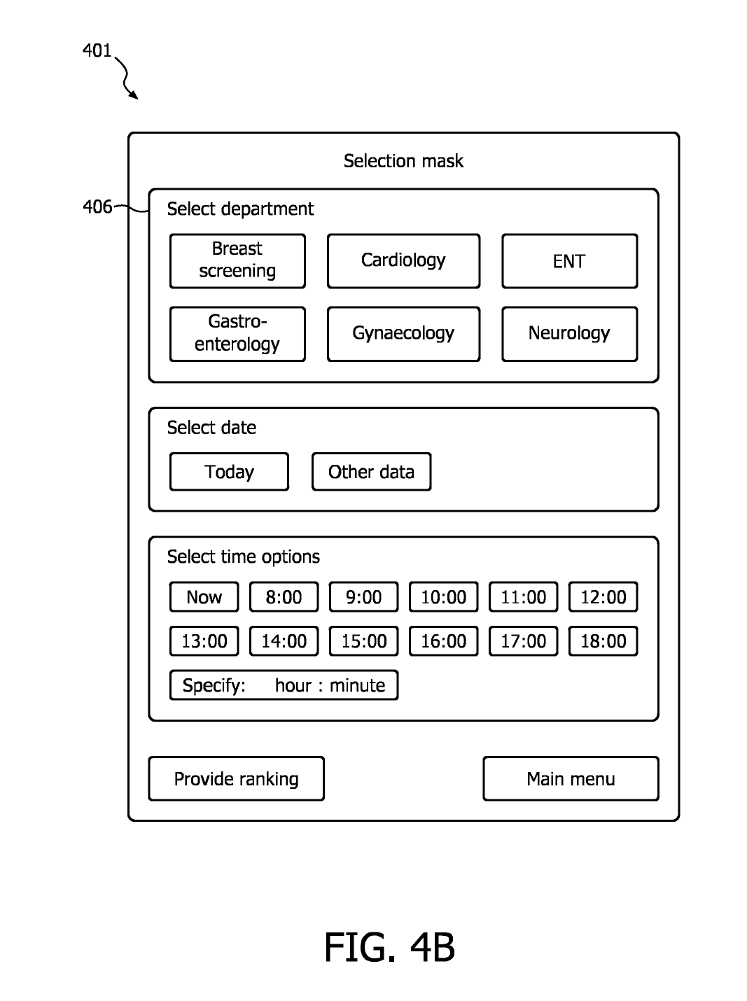

The user selects these options from a user menu. Examples of such a user menu are shown in FIGS. 4A and B. Once the user selects Hospital 405 from the Select establishment section 402 in the Selection interface 400, the Select establishment section 402 changes to a Select department section 406 which allows the user to further specify his request. In this example, different departments of a hospital, such as Breast screening, Cardiology, ENT (Ear nose and throat), Gastroenterology, Gynaecology and Neurology can be selected.

The same principle can be applied for other establishments to specify the request. For instance, if the user selects Restaurant 407 from the Select establishment section 402, more specific options, such as “Chinese”, “Greek”, “Halal”, “Italian”, “Spanish”, “Vegetarian”, “Kosher” etc. may be shown and selected via the user interface (not shown).

The schedule time can be similarly set by selecting date and time 404. The user can select to run the errand at the present moment, at a later time in the same day or several days later. Preferably, the selection interface is configured in such a way that the user is preferably able to select several options. These options may be ranked based on the time required to run a particular errand, as will be described later on.

The method proceeds to identify 320 a user's location and one or more candidate locations where the user can run the target errand. For example, these locations can be stored in a remote database 140c and identified by their latitudes and longitudes. The user's location may be either the current location or a different location from where the user will start to run his errand at a later point in time. This can be provided manually via user input, but is preferably determined by the device via a location sensor, e.g. a GPS. Then the user's location is used by the system to identify nearby establishments of the selected type.

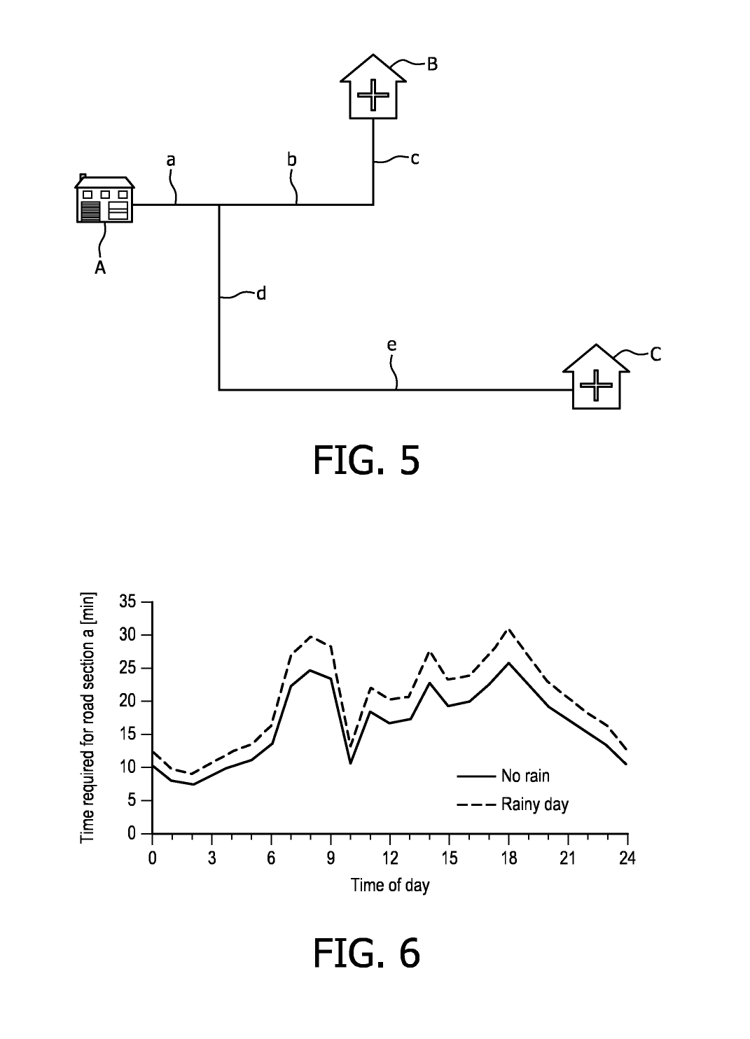

In one embodiment, the system sends the geolocation of the user together with the location/establishment search query (initial user input about desired establishment, such as described above) to a server and the server returns an ordered list of closest locations including their latitude and longitude data. Such a process is well-known and used by numerous apps, and hence will not be further describe here. The user's current location, in this example his home A (FIG. 5), can be visualized together with the identified establishments, in this example hospital B and hospital C, on a display of the device in the form of a map.

As illustrated in FIG. 5, the route from A to B consists of the road segments a, b and c. The route from A to C comprises the road segments a, d and e, correspondingly. In one embodiment, the system uses the sum of the times required for each segment of a particular route (e.g. time tₐ, t_{b} and t_{c} for segments a, b and c, respectively) as the estimated travel time from the user's location A to the desired establishment B. The same is done for all other options. For example, for the route A to C the sum of time tₐ, t_{d} and tₑ corresponding to the segments a, d and e is used.

In an embodiment, the time needed for each segment is retrieved from the traffic database 140a. The system predicates a travel time from the user's location to each of the candidate locations according to the target time schedules. Preferably, the system considers the travel time required for a previous segment when extracting the time required for the following segment. For instance, when the system is calculating the total travel time for an option consisting of several segments, wherein the scheduled departure time of the user from his location is 8 AM and the time required for this 1st segment is 10 minutes at this time, it will extract the travel time for the 2nd segment from the database which corresponds to 8:10 AM.

The method determines available routes and/or available means of transportation from the user's location to each of the candidate locations.

Optionally, real-time traffic data or a combination of real-time and historical data can be used. The traffic database 140a can be created by storing data acquired from e.g. vehicle sensors (like GPS), Automatic vehicle identification (AVI) system sensors or toll booths, to name a few examples. AVI systems for example are installed in many places and therefore widely available. They are able to read vehicle registration plates using surveillance cameras 130 and optical character recognition performed on images acquired by e.g. road-rule enforcement cameras. Such data can be sent e.g. via the internet to service servers and stored in the traffic databases 140a. Two such cameras placed a certain distance apart on a road define a road section. When a vehicle passes the first camera, it is identified and the corresponding time can be stored. The same is done when the vehicle leaves the segment at the position of camera 2. The time required for this particular segment can be simply calculated from the time difference of the 2 time points. Such data can be further processed after acquisition to reduce bias and increase accuracy of the prediction, for example, by calculating the average values from a certain number of cars.

The database 140a can be subdivided into different categories, wherein such categories represent factors having significant impact on the travel time. Such factors can include day of the week, rainy and non-rainy days, National Holidays and so on. FIG. 6 illustrates an exemplary data set from such a database 140a for segment a. The time required by a car for this segment is plotted against the time of day for a rainy and non-rainy day. The time a car needs to travel through a route section A is plotted against the time of day. The upper line represents data for a rainy Monday, and the car may need more time to travel through Section A on a rainy Monday as compared to the lower line representing a non-rainy day.

The method proceeds to estimate 340 a waiting time for running the target errand at each of the candidate locations according to the target time schedules. To determine the waiting time, the system first determines the crowdedness at a candidate location, based on historical data and/or surveillance data of the candidate location according to the target time schedules, and then determines a processing speed at the candidate location. The waiting time can be estimated according to the crowdedness and the processing speed.

According to an embodiment, the waiting time is determined from the historical crowdedness stored in the crowdedness database 140b. The processing speed can either be a speed currently monitored at the location, or a speed derived from a historical database. The crowdedness may be determined from the registration data at a candidate location, the amount of cars at a candidate location, the number of people entering a candidate location, and/or the CO2 concentration at a candidate location.

Based on the waiting time and the travel time predicated above, the method generates a recommendation for at least one of the candidate locations as the target location. The recommended candidate locations are displayed to the user in ascending order according to the sum of the waiting time and the travel time.

According to an embodiment, registration data in a hospital can be used together with e.g. digital patient files to estimate the waiting time. After arrival at the hospital, every patient goes through a registration process. Among other information, the time point of registration is captured. Once the patient enters the physician's room, the patient file is accessed by the doctor. The corresponding time point can be stored as well. The time between patient registration and the physician accessing the patient file can be used to represent the waiting time. Historical databases 140b can be created and used in a way similar to the approach as described above for the estimation of travel time.

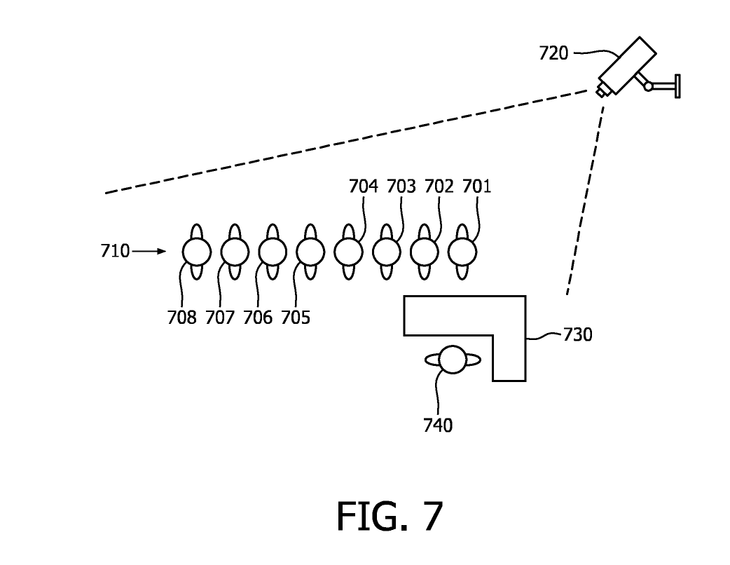

According to an embodiment, the waiting time can be estimated in real time by using the monitoring devices 110 in the hospital. Other relevant digital information, e.g. from cash boxes/tills can also be leveraged. FIG. 7 shows how the waiting time is estimated in real time using a monitoring device, in this case a video camera 720, at a supermarket. The video camera 720 can be positioned in such a way that it captures a queue 710 of customers 701-708 at a till 730. The images captured by the video camera 720 can be processed (e.g. counting the number of people by using a generic head detector) to yield information such as the number of customers N_{c} queuing at a particular time point at the particular till. Every payment determines the time point at which a customer ends his shopping and the time difference between 2 payments can be used to determine the customer processing speed S_{c} of a particular cashier (i.e. time needed by a cashier to process one customer's purchases(?)). In this situation, the waiting time T_{w} can be calculated from the following equation:

T_{w}=N_{c}/S_{c}

Any other suitable way of predicting the waiting/queuing time at a particular establishment can be used by the system. For example, the estimation of the waiting time as described above for a supermarket can be further refined by considering several tills or active service channels. In other embodiments, cameras are placed at the entrance and the exit of an establishment to obtain information about the number of people present in this establishment at a particular time. This number, optionally combined with other information such as the number of active service channels, can be used to estimate the waiting time.

Based on the waiting time and the travel time predicated above, the method generates a recommendation for at least one of the candidate locations as the target location. The recommended candidate locations are displayed to the user in ascending order according to the sum of the waiting time and the travel time.

To determine the total amount of time needed to run a particular errand, the system adds up the travel time and the waiting time for each identified establishment and for each time schedule initially selected by the user. Simultaneously it considers the starting time (time when user intends to leave his current location to run the errand) and the travel time to select the corresponding waiting time. Table 2 illustrates this process using a simplified example. The user has initially selected 8 AM, 10 AM and 2 PM as his preferences. The system accesses the databases and extracts the estimated travel time for the 2 identified establishments B and C. For example, if the user departs at 8 AM to establishment B, the estimated travel time is 70 minutes. Therefore he would arrive at 9:10 AM. The system subsequently extracts the waiting time for establishment B corresponding to 9:10 AM, which is 15 minutes. The total time to run this particular errand at this particular time is 85 minutes.

TABLE 1

| | | Estimated | Estimated | Estimated | |
|---|---|---|---|---|---|
| | Departure | travel time | arrival | waiting time | Total time |
| | time | [min] | time | [min] | [min] |
| Estab- | 8:00 | 70 | 9:10 | 15 | 85 |
| lishment | 10:00 | 45 | 10:45 | 10 | 55 |
| B | 14:00 | 60 | 15:00 | 30 | 90 |
| Estab- | 8:00 | 50 | 8:50 | 60 | 110 |
| lishment | 10:00 | 30 | 10:30 | 20 | 50 |
| C | 14:00 | 70 | 15:10 | 45 | 115 |

According to an embodiment, table 1 may be not visible to the user.

Finally, the ranking process is performed, wherein the system sorts all options (rows in table 1) based on the column “Total time [min]” from the minimum value in position 1 in ascending order.

The final table preferably includes the establishments, departure times and total time needed for each option, as illustrated in table 2. This table may be shown to the user on the display 180 of the disclosed system or the display 280 of the target recommending device 120. This output informs the user about the total time needed and allows him to make a final choice.

TABLE 2

| | Departure | Total time |
|---|---|---|
| Establishment | time | [min] |
| B | 10:00 | 50 |
| A | 10:00 | 55 |
| A | 8:00 | 85 |
| A | 14:00 | 90 |
| B | 8:00 | 110 |
| B | 14:00 | 115 |

The above approaches for predicting waiting time and travel time are described for illustration rather than limitation purposes. Although the illustrative embodiments of the present invention have been described in greater detail with reference to the accompanying drawings, it will be understood that the invention is not limited to those embodiments. Various changes or modifications may be effected by one skilled in the art without departing from the scope or the spirit of the invention as defined in the claims.

1. A device for generating a recommendation for one or more target locations for running a target errand, including:
a schedule setting module for determining one or more target time schedules when a user intends to run the target errand,
a location identifying module for identifying the user's location and one or more candidate locations where the user can run the target errand,
a travel time predicating module for predicating a travel time from the user's location to each of the candidate locations according to the target time schedules,
a waiting time estimating module for estimating a waiting time for running the target errand at each of the candidate locations according to the target time schedules, and
a recommending module for generating a recommendation for at least one of the candidate locations as the target location, based on the waiting time and the travel time.

2. The device according to claim 1, wherein the travel time predicating module is configured to determine available routes and/or available means of transportation from the user's location to each of the candidate locations.

3. The device according to claim 2, wherein the travel time predicating module is configured to:
select a route from a plurality of available routes,
divide the selected route into multiple segments,
estimate a segment time of each of the multiple segments from historical traffic data and/or real-time traffic data according to the target time schedules, and add up all estimated segment times for the selected route.

4. The device according to claim 1, wherein the waiting time estimating module is configured to estimate the crowdedness of a candidate location, based on historical data and/or surveillance data of the candidate location according to the available time schedule.

5. The device according to claim 1, further comprising: a display for displaying the recommended candidate locations in ascending order according to the sum of the waiting time and the travel time.

6. A system for generating a recommendation for one or more target locations for running a target errand, comprising:
the device of claim 1; and
historical data storage means communicatively coupled to the device for providing information selected from a group comprising:
candidate locations for different types of errands,
available routes and/or means of transportation to the candidate locations, historical traffic data, and/or
historical crowdedness data at the candidate locations.

7. The system according to claim 6, further comprising:
monitoring devices for monitoring the crowdedness at the candidate locations, and
surveillance devices for monitoring real-time traffic data.

8. A method of generating a recommendation for one or more target locations for running a target errand, including the steps of:
determining one or more target time schedules when a user intends to run the target errand,
identifying the user's location and one or more candidate locations where the user can run the target errand,
predicting travel time from the user's location to each of the candidate locations according to the target time schedules,
estimating a waiting time for running the target errand at each of the candidate locations according to the target time schedules, and
generating a recommendation for at least one of the candidate locations as the target location, based on the waiting time and the travel time.

9. The method according to claim 8, wherein the step of predicating the travel time comprises the step of determining available routes and/or available means of transportation from the user's location to each of the candidate locations.

10. The method according to claim 9, wherein the step of predicating the travel time comprises steps of:
selecting a route from a plurality of available routes,
dividing the selected route into multiple segments,
estimating a segment time of each of the multiple segments from historical traffic data and/or real-time traffic data according to the target time schedules, and
adding up all estimated segment times for the selected route.

11. The method according to claim 8, wherein the step of estimating the waiting time at each candidate location further comprises the steps of:
determining the crowdedness at a candidate location, based on historical data and/or surveillance data of the candidate location according to the target time schedules,
determining a processing speed at the candidate location, and estimating the waiting time according to the crowdedness and the processing speed.

12. The method according to claim 11, wherein the crowdedness is determined from the registration data at a candidate location, the amount of cars at a candidate location, the number of people entering a candidate location, and/or the CO₂ concentration at a candidate location.

13. The method according to claim 11, wherein the waiting time is estimated according to the target time schedules and the travel time.

14. The method according to claim 8, wherein the recommended candidate locations are displayed to the user in ascending order according to the sum of the waiting time and the travel time.

15. A computer readable storage medium comprising instructions stored thereon that are responsive to execution by a processor, causes the processor to perform a method according to claim 8.
